(19) United States
(12) Patent Application Publication
(10) Pub. No.: US 2012/0096957 A1
(43) Pub. Date: Apr. 26, 2012

(54) PIPETTE DIFFERENTIATION

(75) Inventor: Eitan OCHMAN, Kibbutz Metzer (IL)

(73) Assignee: Miniplast Ein-Sherner Agricultural Cooperative Society Ltd., Kibbutz Ein-Shemer (IL)

(21) Appl. No.: 13/279,342

(22) Filed: Oct. 24, 2011

Related U.S. Application Data
(60) Provisional application No. 61/406,615, filed on Oct. 26, 2010.

(51) Int. Cl. B01L 3/02

(52) U.S. Cl. 73/864.01

(57) ABSTRACT

A pipette for transferring a volume of liquid, a portion of the pipette formed from a material tinted with a color associated with the pipette volume, facilitating the differentiation of the pipette from other pipettes of different volumes. The portion of the pipette that is tinted may include at least a portion of the pipette top, the pipette body, or the pipette tip. The color tinting may correspond to a color coding standard. The pipette may include additional differentiation characteristics, such as the shape of the pipette, the presence of at least one colored band on the surface of the pipette, the presence of at least one colored material inserted into the pipette top of the pipette, or the presence of a solid colored pipette top.

### FIELD OF THE DISCLOSED TECHNIQUE

The disclosed technique relates to laboratory measurement equipment in general, and to pipettes and methods for identifying different volumetric measurements of the pipettes, in particular.

### BACKGROUND OF THE DISCLOSED TECHNIQUE

Pipettes are used in various fields to transport measured volumes of liquid, such as in biology laboratories, medical analyses, serology, immunology, microbiology, tissue cultures, industrial laboratories, and the like. In many experiments and applications, an accurate amount of a specific liquid is required for following the correct laboratory procedure and for enabling the success of the experiment or application. Different pipettes may appear similar, especially when they are clustered together. Thus, when many pipettes with different volumes are mixed together, it is difficult to distinguish between them, particularly when a large number of manipulations are required, or if the manipulations need to be implemented quickly. Thus, a user many unintentionally mistake one pipette for another, thereby potentially jeopardizing the intended experiment or application results.

Depending on the individual application, laboratory requirements and methodologies, pipettes may be disposable after only a single use, or after a few usages, or may be re-usable over a long term. Thus, depending on the intended usage, a corresponding cost and hence manufacturing cost consideration is required. For single use disposable pipettes, the price sensitivity of each pipette is very high and in corollary so is the cost of manufacturing. This manufacturing cost sensitivity is also felt with re-useable pipettes, however with the extra sensitivity of considering the longevity of the graduation graphics on the pipettes and well as the durability of the pipettes. Thus, reducing the manufacturing costs of pipettes of various intended usages, be it disposable or non disposable, is a focus of many manufacturers and innovators in the pipette manufacturing industry.

Pipette types include: volumetric, serologic, one-mark, graduated, Pasteur, open end, and wide tip pipettes, as well as other measurement apparatuses known in the art. In the laboratory setting, pipettes can be easily mistaken for one another. Therefore, color coding and other differentiation standards corresponding to the different volumetric measurements of different pipettes have been introduced. Such color coding standards include: ASTM E1273, ASTM E1293, ASTM E1157, ASTM E 943, ASTM E1044 and ISO 1769:1975. ASTM E1273 is a specification for reusable laboratory pipettes for identification of nominal capacities and units of sub-division. ASTM E1273 applies to one-mark, and graduated pipettes of nominal capacities. ASTM E1293 is a specification that covers requirements of precision (class A) and general purpose (class B) grade glass measuring pipettes used for volume measurement of liquids. ASTM E1157 is a specification for sampling and testing of reusable laboratory equipment. ASTM, E 943 is a specification that covers disposable plastic serological pipettes, calibrated to deliver when measuring volumes of liquids. These pipettes are fabricated from crystal-grade, uncolored polystyrene, or its regrind. ASTM E1044 is a specification that covers reusable glass serological pipettes used for measuring volumes of liquid. The pipettes may be classified into three styles according to operational set-up and should be made with approved glass materials. ISO 1769:1975 is another color coding standard for laboratory glassware, specifically pipettes.

It is currently known in the art to provide color bands on a pipette in accordance with the color coding systems herein mentioned. It is also currently known in the art to provide a filter in the top of the pipette in order to avoid contamination. In some cases, this filter is synthetic, cotton, or string, and is provided in a color corresponding with some of the color coding systems herein mentioned. Nevertheless, inserted colored strings and materials pose the risk of contaminating the measured fluid being suctioned into the pipette. Additionally, careful attention to the string thickness is required so that the colored string does not fall into or out of the pipette. Alternatively, the colored string may not fit into the pipette properly, or may restrict the negative pressure that suctions in the liquid being measured. Manufacturing these additional materials to be inserted into the pipettes, as well as actually inserting them into the pipettes, incurs added costs to the pipette manufacturing process. Similarly, painting on color bands corresponding to the volumetric color coding standards increases the costs of manufacturing pipettes. The color bands may also be read incorrectly, as they are after all thin bands on the surface of the pipettes.

European Patent No. EP 261,023 to ALP Articles de Laboratoire de Precision S.A., entitled “Identification method for a laboratory instrument, and pipette identified accordingly by colours”, discloses a method for identifying a laboratory instrument comprising at least one transparent tube enabling the user to identify immediately and unmistakably at least one of its characteristics, such as its maximum volume. A piece of colored material is inserted into the interior of the transparent tube in such a way that the material will be visible from the outside in all conditions, providing a means of identification.

### SUMMARY OF THE DISCLOSED TECHNIQUE

In accordance with the disclosed technique, there is thus provided a pipette for transferring a volume of liquid, where at least, a portion of the pipette is formed from a material that is tinted with a color associated with the pipette volume, facilitating the differentiation of the pipette from other pipettes of different volumes. The portion of the pipette that is tinted may include at least a portion of the pipette top, the pipette body or the pipette tip. The pipette tip and/or the pipette top may be connected to the pipette body by melting, gluing, screwing, or integrally forming using one piece of material. The color tinting may correspond to a color coding standard, such as ASTM E1273, ASTM E1293, ASTM E1157, ASTM E943, ASTM E1044, or ISO 1769:1975. The pipette may be a volumetric, serologic, one-mark, graduated, Pasteur, open end, wide tip pipette, or another type of pipette or measuring apparatus. Other differentiation characteristics may be used in addition to color tinting a portion of the pipette. Such differentiation characteristics may include the shape of the pipette, the presence of at least one colored band, on the surface of the pipette, the presence of at least one colored materiel inserted into the pipette top of the pipette, and the presence of a solid colored pipette top.

In accordance with the disclosed technique, there further provided a method for facilitating the differentiation of a pipette from other pipettes of different volumes. The method includes the procedure of forming at least a portion of the pipette from a material that is tinted with a color associated with the pipette volume of said pipette. The portion of the pipette that is tinted may include at least a portion of the pipette top, the pipette body or the pipette tip. The pipette top and/or pipette tip may be connected to the pipette body by melting, gluing, screwing, or integrally forming, using one piece of material. The color tinting may correspond to a color coding standard, such as ASTM E1273, ASTM E1293, ASTM E1157, ASTM E943, ASTM E1044, or ISO 1769:1975. The pipette may be a volumetric, serologic, one-mark, graduated, Pasteur, open end, wide tip pipette, or another type of pipette or measuring apparatus. Other differentiation characteristics may be used in addition to color tinting a portion of the pipette. Such differentiation characteristics may include the shape of the pipette, the presence of at least one colored band on the surface of the pipette, the presence of at least one colored material inserted into the pipette top of the pipette, and the pretence of at solid colored pipette top.

### BRIEF DESCRIPTION OF THE DRAWINGS

The disclosed technique will be understood and appreciated more fully from the following detailed description taken in conjunction with the drawings in which:

FIG. 1 is a schematic, side view illustration of a pipette and pipette gravure, constructed and operative in accordance with an embodiment of the disclosed technique;

FIG. 2 is a schematic side view illustration of a pipette and multiple exemplary pipette gravures, constructed and operative in accordance with another embodiment of the disclosed technique;

FIG. 3 is a schematic side view illustration of two graduated pipettes, constructed and operative in accordance with a further embodiment of the disclosed technique.

FIG. 4 is a schematic side view illustration of a one-mark pipette, constructed and operative in accordance with yet another embodiment of the disclosed technique.

### DETAILED DESCRIPTION OF THE EMBODIMENTS

The disclosed technique overcomes the disadvantages of the prior art by providing a novel pipette configuration and a method for easily identifying different pipettes corresponding to their different volumetric measurements. The pipettes are manufactured using color tinted materials, for example glass or plastics, that correspond to known or new color coding standards for the corresponding pipette volumetric measurements. The color tinting of the pipettes enables quick and simple differentiation between the different pipettes, while still allowing the user to easily observe and measure the liquids being suctioned into the pipettes. The pipettes can be manufactured completely or partially from the tinted material. For example only a horizontal, or alternatively, a vertical strip of tinted material may be used to manufacture the pipettes. The disclosed technique provides significant cost saving benefits to the manufacturing and assembly process of pipettes.

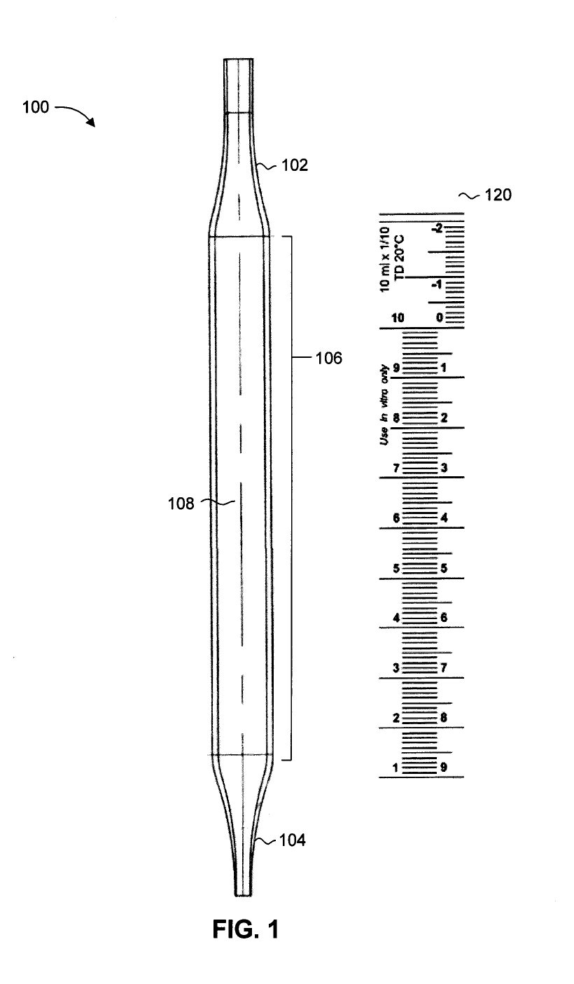

Reference is now made to FIG. 1, which is a schematic side view illustration of a pipette, referenced 100, and pipette gravure, referenced 120, constructed and operative in accordance with an embodiment of the disclosed technique. Pipette 100 is composed of pipette top 102, pipette tip 104 and pipette body 106. Pipette top 102, pipette tip 104 and pipette body 106 are integrally formed from a single piece of material. Gravure 120 is printed onto the surface of pipette 100. Pipette 100 is preferably made of glass, but may alternatively be formed from other materials, such as plastics, or other materials known in the art. Pipette 100 functions as a result of negative suction pressure applied from pipette top 102 to the air 108 inside pipette 100, suctioning the desired liquid (not shown) into pipette body 106 through pipette tip 104. The negative suction pressure is generated by a pipette aid (not shown) that is attached to pipette top 102. The pipette aid (not shown) may be a filler, a pipette pump, an electronic controller, or any other type of pipette aid known in the art. The maximum volumetric measurement of pipette 100, as is illustrated by gravure 120 of FIG. 1, is 10 ml. Hence, the user of pipette 100 can accurately measure up to 10 ml of liquid using pipette 100.

The material from which pipette 100 is formed is tinted to correspond to an aforementioned color coding standard, or alternatively, to a completely new color coding standard which corresponds to a 10 ml volumetric measurement. The tinted material is tinted such that it allows easy differentiation between different pipettes with different volumetric measurements, while at the same time allowing the pipette user to easily observe and read the meniscus level of the liquid inside pipette 100, and compare it to the graduation marks on the pipette, thereby enabling quick, simple and accurate measurements of the liquid inside pipette 100.

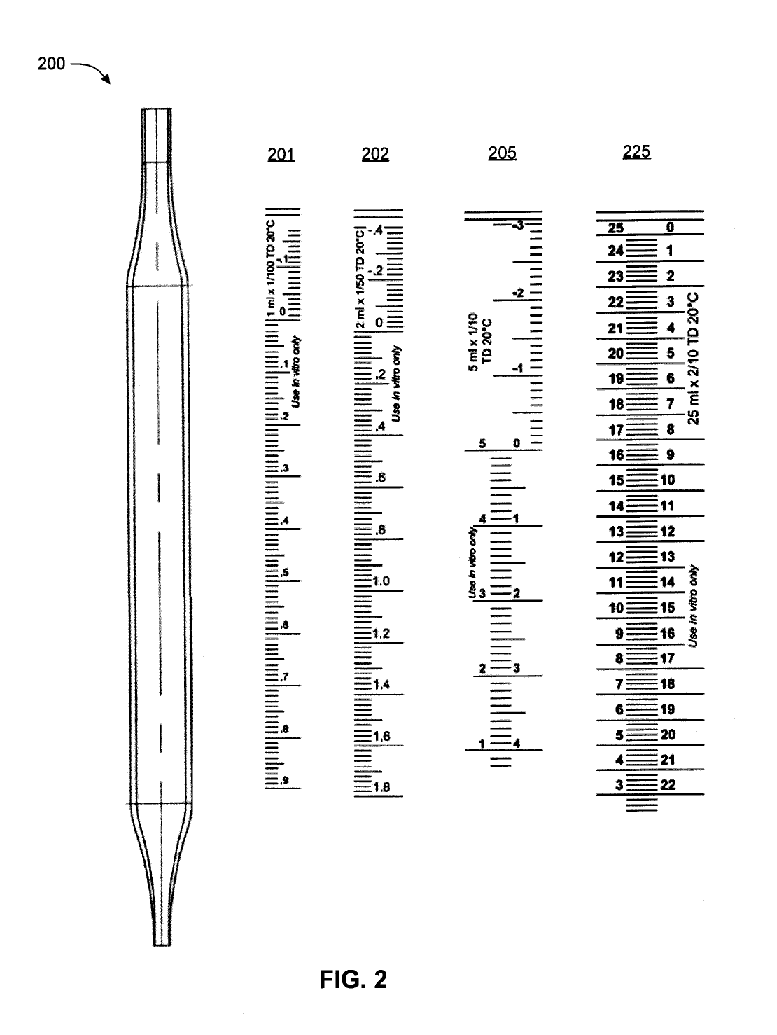

Reference is now made to FIG. 2, which is a schematic side view illustration of a pipette, referenced 200, and multiple exemplary pipette gravures, referenced 201, 202, 205 and 225, respectively, constructed and operative in accordance with another embodiment of disclosed technique. Pipette 200 represents a generic pipette that can have various different volumetric measurements. Pipette 200 is similar to pipette 100 (FIG. 1), except for mentioned differences in volumetric) measurements and dimensions. Gravures markings 201, 202, 205 and 225 correspond to pipettes 200 of volumetric measurements measuring up to 1 ml, 2 ml, 5 ml and 25 ml, respectively, and may be printed on them accordingly. Similarly to pipette 100 (FIG. 1), pipettes 200 of different volumetric measurements 1 ml, 2 ml, 5 ml and 25 ml are manufactured using tinted materials corresponding to each of their respective color coding matches, according to a known or new color coding standard. It is understood that the aforementioned volumetric measurements are merely provided as examples, and that the disclosed technique is also, extendible to other volumetric measurements.

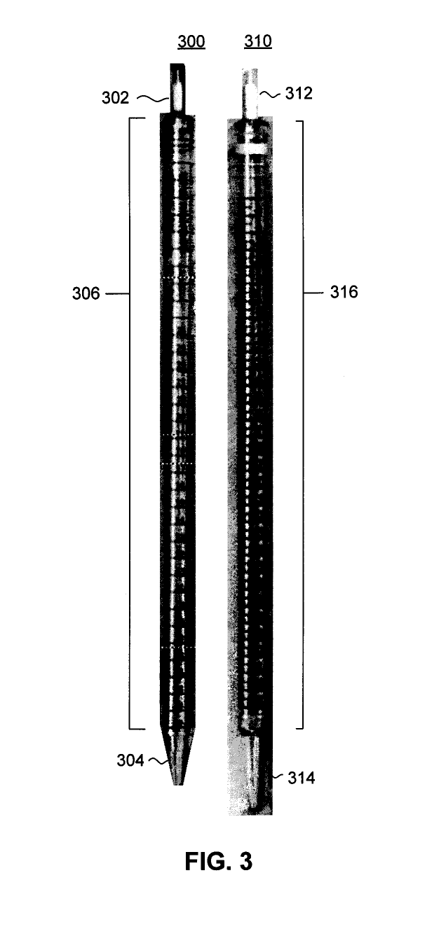

Reference is now made to FIG. 3, which is a schematic side view illustration of two graduated pipettes, referenced 300 and 310, constructed and operative in accordance with a further embodiment of the disclosed technique. Pipette 300 includes pipette top 302, pipette lip 304 and pipette body 306. Pipette 310 includes pipette top 312, pipette tip 314 and pipette body 316. Pipette 300 and 310 are each generally analogous to pipette 100, with the exceptions of different volumetric measurements, different pipette dimensions, and that pipette tops 302 and 312 and pipette tips 304 and 314 are connected to pipette bodies 306 and 516, respectively, rather than being integrally formed with a single continuous piece of material as with the components of pipette 100. In pipette 300, pipette top 302 is a separate portion which is connected to pipette body 306. Pipette top 302 may be connected by gluing, screwing on, or by another connection method known in the art. Similarly to pipette 100, pipette tip 304 is integrally formed into pipette body 306 with a single piece of material. In pipette 310, pipette top 312 and pipette tip 314 are separate portions which are connected to pipette body 316 (e.g., by gluing, screwing on, or by another connection method known in the art). It is understood that the pipette tops 302 and 312 may be manufactured from the same color tinted material corresponding to the color coding of the volumetric measurements of the different pipettes, or alternatively, a different color tinted material. Similarly, pipette tip 314 may be manufactured from the same color tinted material corresponding to the color coding of the volumetric measurements of the different pipettes, or alternatively, a different color tinted material.

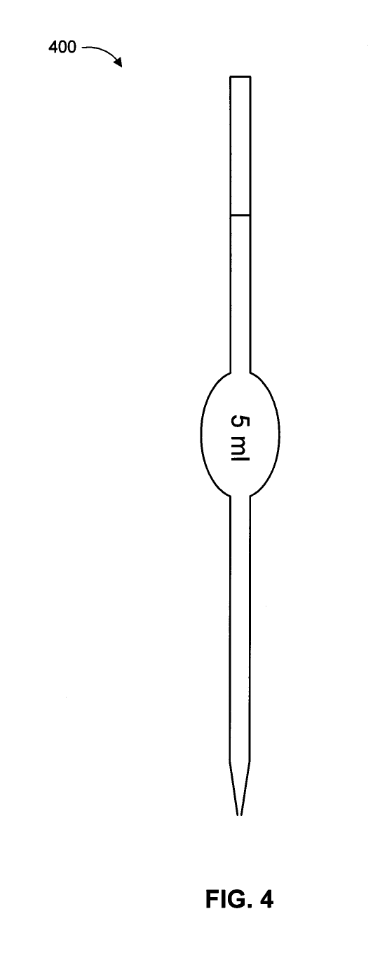

Reference is now made to FIG. 4, which is schematic side view illustration of a 5 ml one-mark pipette, referenced 400, constructed and operative in accordance with yet another embodiment of the disclosed technique. As with the graduated pipettes described hereinabove with reference to FIGS. 1, 2 and 3), one-mark pipette 400 is manufactured from a tinted transparent material, in order to enable quick and simple differentiation from similar pipettes of different volumetric measurements. It is understood that one-mark pipettes of other volumetric measurements (i.e., other than 5 ml) may be manufactured from, differently tinted materials corresponding to their volumetric measurements, according to color coding standards.

It is further noted that the disclosed technique may be applied to pipettes in conjunction with other pipette identification means known in the art, such as the use of colored bands on the surface of pipettes, inserting colored material into the pipette top, adapting the shapes of different parts of the pipettes, or the like.

It will be appreciated by persons skilled in the art that the technique is not limited to what has been particularly shown and described hereinabove.

1. A pipette for transferring a volume of liquid, wherein at least a portion of said pipette is formed from a material that is tinted with a color associated with the pipette volume of said pipette, facilitating the differentiation of said pipette from other pipettes of different volumes.

2. The pipette according to claim 1, wherein said portion comprises at least one pipette region selected from the list consisting of:
the pipette top;
the pipette body; and
the pipette tip.

3. The pipette according to claim 2, wherein said pipette tip is coupled to said pipette body by a process selected from the list consisting of:
melting;
gluing;
screwing; and
integrally forming using a single piece of material.

4. The pipette according to claim 2, wherein said pipette top is coupled to said pipette body by a process selected from the list consisting of:
melting;
gluing;
screwing; and
integrally forming using one piece of material.

5. The pipette according to claim 1, wherein said color corresponds to a color coding standard selected from the list consisting of:
ASTM E1273;
ASTM E1293;
ASTM E1157;
ASTM E943;
ASTM E1044; and
ISO 1769:1975.

6. The pipette according to claim 1, wherein said pipette is selected from the list consisting of:
volumetric pipette;
serologic pipette;
one-mark pipette;
graduated pipette;
Pasteur pipette;
open end pipette; and
wide tip pipette.

7. The pipette according to claim 1, further comprising an additional differentiation characteristic selected from the list consisting of:
the shape of said pipette;
the presence of at least one colored band on the surface of said pipette;
the presence of at least one colored material inserted, into the pipette top of said pipette; and
the presence of a solid colored pipette top.

8. The pipette according to claim 1, wherein said material is selected from the list consisting of:
glass; and
plastic.

9. A method for facilitating the differentiation of a pipette from other pipettes of different volumes, the method comprising the procedure of forming at least a portion of said pipette from a material that is tinted with a color associated with the pipette volume of said pipette.

10. The method according to claim 9, wherein said portion comprises at least one pipette region selected from the list consisting of:
the pipette top;
the pipette body; and
the pipette tip.

11. The method according to claim 10, wherein method further comprises the procedure of coupling said pipette tip to said pipette body by a process selected from the list consisting of:
melting,
gluing,
screwing; and
integrally forming using a single piece of material.

12. The method according to claim 10, wherein said method further comprises the procedure of coupling said pipette top to said pipette body by a process, selected from the list consisting of:
melting,
gluing,
screwing; and
integrally forming using a single piece of material.

13. The method according to claim 9, wherein said color corresponds to a color coding standard selected from, the list consisting of:
ASTM E1273;
ASTM E1293;
ASTM E1157;
ASTM E943;
ASTM E1044; and
ISO 1769:1975.

14. The method according to claim 9, wherein said pipette is selected from the list consisting of:
volumetric pipette;
serologic pipette;
one-mark pipette;
graduated pipette;
pasteur pipette;
open end pipette; and
wide tip pipette.

15. The method according to claim 9, further comprising the procedure of applying an additional differentiation characteristic to said pipette, said additional differentiation characteristic selected from the list consisting of:
the shape of said pipette;
the presence of at least one colored band on the surface of said pipette;
the presence of at least one colored material, inserted into the pipette top of said pipette; and
the presence of a solid colored pipette top.

16. The method according to claim 9, wherein said material is selected from the list consisting of:
glass, and
plastic.
